(19) United States
(12) Patent Application Publication
(10) Pub. No.: US 2009/0304182 A1
(43) Pub. Date: Dec. 10, 2009

(54) System and method for providing information using audio watermarking

(75) Inventors: Hyuk Choi, Seoul (KR); Young-Jin Yun, Seoul (KR)

Correspondence Address: CHERNOFF, VILHAUER, MCCLUNG & STENZEL, LLP, 601 SW Second Avenue, Suite 1600, PORTLAND, OR, 97204-3157, US

(73) Assignees: Mobilians Co., Ltd., Seoul (KR); Istlab, Inc., Seoul (KR)

(21) Appl. No.: 11/919,273

(22) PCT Filed: Nov. 7, 2006
(86) PCT No.: PCT/KR2006/004634

§ 371 Date: Oct. 24, 2007

(30) Foreign Application Priority Data
Sep. 29, 2006 (KR) 10-2006-0095603

(51) Int. Cl. H04K 1/02

(52) U.S. Cl. 380/252

(57) ABSTRACT

A system for providing information using a watermarking technique includes a signal generating means for inserting an information data into a sound source to generate an audio signal having the information data; a signal transmitting means for transmitting the audio signal to a user terminal; and an information extracting means for extracting the inserted information data from the audio signal, and the information extracting means is configured separately from the user terminal, and receives the audio signal from the user terminal, extracts the information data from the audio signal, transmits the extracted information data to the user terminal to provide the information data to the user. Therefore, the user can be provided with related information and corresponding contents through the sound source regardless of time, space, and online or offline. Further, the system provides information using audio watermarking with high robustness and reduced detection time.

### TECHNICAL FIELD

The present invention relates to a system and method for providing information using an audio watermarking, and in particular, to a system for providing information which inserts an information data into a general sound source using a watermarking technique to generate a watermarked audio signal, and extracts the information data from the watermarked audio signal to provide the information data to a user, and a method thereof.

### BACKGROUND ART

With rapid and broad growth of information industry, digitization of various multimedia contents, and rapid development of a very high speed communication network such as Internet in these days, multimedia digital data is distributed very last, easily and widely, and information has very great worth in a digital world and can be accessed in various types due to development of information communication techniques.

As techniques develop rapidly, we are provided with much media information we have not recognized, and we select and obtain our desired information from the multimedia information according to necessity. For example, a large number of information is provided from TV, radio. Internet or electric signs installed on the roadside, and we obtain information as it is, and for more detailed information, we should search and obtain necessary information by ourselves. For instance, when we walk on the roadside and then watch the news from a TV, for more detailed information of the news, we should search and obtain a detailed information by ourselves through newspaper, magazine or Internet.

However, when we obtained our desired primary information, if we immediately obtain secondary information without special efforts and time, efficiency will considerably increase.

The present invention suggests a system in which a user can immediately obtain secondary information according to necessity when the user obtained primary information, and a method thereof.

An audio watermarking technique is used for the above-mentioned purpose, and will be apparent below for better understanding of the present invention.

Originally, the term of ‘watermark’ derives from a bill manufacturing process, and a digital watermarking is currently used in protecting intellectual property.

The trend of multimedia toward digitization is accelerated due to its convenience in manufacturing, edition, processing, transmission and storage, and data of digitized materials, i.e. documents, images or sound can be easily copied and distributed. As a result, various problems may occur, for example permission, compensation and restriction required to use a user's desired information, copying, transmission and distribution of information to be used, or rights of an authority or an individual possessing the information, and digital audio data of high sound quality such as MPEG or MP3 which is used in Internet newspaper, magazine, TV, radio or digital books is illegally distributed, and thus it requires a method for preventing illegal distribution and protecting intellectual property.

FIG. 1 schematically illustrates watermarking, and the watermarking is used as a protection means to solve the problems, besides it may be used for property claim, electronic fingerprint, authentication and integrity identification, additional information insertion or user limit according to usage.

An audio watermarking conceals an inaudible information in an original signal using an auditory characteristic of a human. A watermarking system largely includes an encryption process and a decryption process, and as shown in FIG. 2(a), the encryption process as an insertion algorithm inserts a watermark information into medium in the unrecognizable range, and as shown in FIG. 2(b), the decryption process as a detection algorithm detects the watermark information inserted in the medium.

Particularly, when watermarking is applied to contents, it requires to consider transparency and robustness, and transparency is a characteristic for easily recognizing a difference between an original content and a watermarked content, and robustness is a characteristic for protecting the inserted watermark from various attacks. In the case of an audio watermarking for inserting information into an audio signal, a human is more susceptible to an audible information than a visible information, and thus it is known that damage of an audio signal is recognized more easily than damage of a video signal. Therefore, when watermarking used in an image signal is applied to an audio signal as it is, a sound quality may be deteriorated, or when a faint watermarking is inserted, robustness may be reduced, and thus it requires to use a watermarking method taken an audio characteristic into consideration.

### [Disclosure]

### [Technical Problem]

The present invention is designed to solve the problems of the prior art, and therefore it is an object of the present invention to provide a system and method in which, when a user obtained a primary information, the user can easily obtain more detailed information or a secondary information related to the primary information.

And, the present invention provides a system and method in which an information data is inserted into a sound source using a watermarking technique and provided to a user so that the user can conveniently use information data regardless of time and space.

Further, the present invention provides a system and method for providing information using an effective audio watermarking having improved transparency and robustness, available offline as well as online to be adapted to the above-mentioned circumstance.

### [Technical Solution]

In order to achieve the above-mentioned objects, a system for providing information using an audio watermarking according to the present invention, which inserts a specific information into a general sound source using the audio watermarking and provides the information to a user, includes a signal generating means for inserting an information data into the sound source to generate an audio signal; a signal transmitting means for transmitting the audio signal generated by the signal generating means to a user terminal; and an information extracting means for extracting the inserted information data from the audio signal, wherein the information extracting means is configured separately from the user terminal, and receives the audio signal from the user terminal, extracts the information data from the audio signal and transmits the extracted information data to the user terminal to provide the information data to the user.

The user terminal for receiving the audio signal having the information data and providing the information data to the user includes a receiving means for receiving the audio signal; a storage means for storing the audio signal; and an information managing means for transmitting the audio signal to the information extracting means configured separately from the user terminal, receiving the extracted information data from the information extracting means and providing the information data to the user, the user terminal extracts the information data from the audio signal through the information extracting means configured separately from the user terminal and provides the information data to the user.

Further, the signal generating means inserts information to be provided to the user into a frequency domain of the sound source through DFT (Discrete Fourier Transform), and converts a signal of frequency domain having the inserted information into a signal of time domain through IDFT (Inverse Discrete Fourier Transform) to generate the audio signal having the information.

More further, the sound source is divided into segment blocks, each segment block is divided into a plurality of samples, a frequency domain of each segment block is calculated through DFT, and the information data is inserted in frequency domain of 500 Hz to 5000 Hz among frequency domain of the sound source.

Preferably, after a sync watermark representing a start portion of the information data is inserted once, the information data is inserted at least once, and this step is repeated over the entire domain of the sound source.

The information extracting means calculates the frequency domain of the audio signal through DFT, extracts the inserted information from the calculated frequency domain through correlation detection, and transmits the information to the user terminal, and the audio signal is divided into segment blocks, and the correlation detection is made skipping over at a predetermined interval in each segment block.

And, a method for providing information using an audio watermarking, which inserts a specific information into a general sound source and provides the information to a user, includes inserting an information data to be provided to the user into the sound source to generate an audio signal having the information data; transmitting the audio signal to an audio output device adjacent to the user; receiving the audio signal through a user terminal; extracting the information data from the audio signal; and providing the information data to the user.

Preferably, a step of extracting the information data includes storing the audio signal in the user terminal; the user terminal connecting to an information extracting server to transmit the audio signal to the information extracting server; the information extracting server extracting the information data from the audio signal; and the information extracting server transmitting the extracted information data to the user terminal.

More preferably, in a step of transmitting the audio signal, the audio signal is transmitted as a sky wave broadcasting signal and received by an audio output device adjacent to the user.

Further, the method further includes the user terminal operating a link program based on the information data.

More further, the method further includes, in the case that the information data contains a URL information, connecting the user terminal to a corresponding site based on the URL information, and when the user terminal is connected to the corresponding site, a server of the corresponding site providing a corresponding content to the user based on the information data.

### DESCRIPTION OF DRAWINGS

FIG. 1 schematically illustrates the use of watermark.

FIG. 2(a) illustrates an insertion algorithm in an encryption process of watermarking, and FIG. 2(b) illustrates a detection algorithm in a decryption process of watermarking.

FIG. 3 schematically illustrates a system for providing information to a user using watermarking according to the present invention.

FIG. 4 schematically illustrates a configuration in which an event discount coupon information is inserted into a concert advertisement and provided to the user in accordance with an exemplary embodiment of the present invention.

FIG. 5 schematically illustrates a configuration in which an information data is inserted into a sound source using watermarking according to the present invention.

FIG. 6(a) illustrates the waveform of a general sound source, and FIG. 6(b) illustrates the sound source divided into the N number of segment blocks.

FIG. 7 illustrates an embodiment in which a sync watermark is inserted over the entire domain of the sound source.

FIG. 8 schematically illustrates a configuration in which the information data is extracted from the audio signal having the inserted information data in accordance with the present invention.

FIG. 9 is a schematic flowchart of a method for providing information using watermarking in accordance with the present invention.

FIG. 10 is a schematic flowchart of a step for extracting the information data using an information extracting means in accordance with the present invention.

FIG. 11 is a schematic flowchart of a step for generating the audio signal having the inserted information data in accordance with the present invention.

FIG. 12 is a schematic flowchart of a step for extracting the information data from the audio signal in accordance with the present invention.

FIG. 13 is a schematic flowchart of a step for providing the information data in accordance with the present invention.

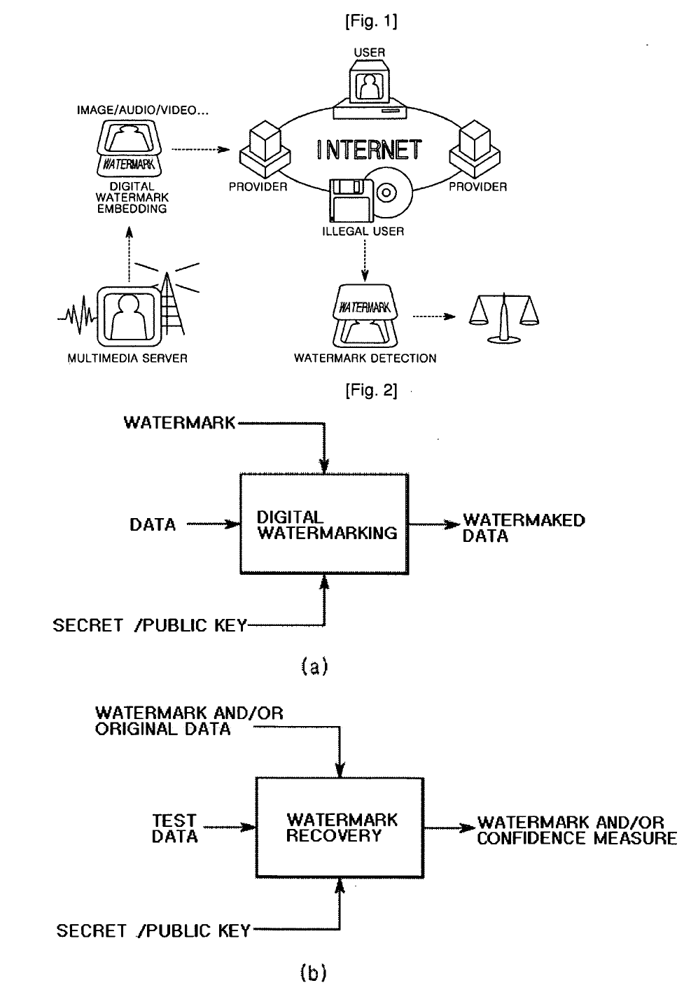

### BEST MODE

Hereinafter, a system and method for providing information using audio watermarking in accordance with the present invention will be described in detail with reference to the accompanying drawings.

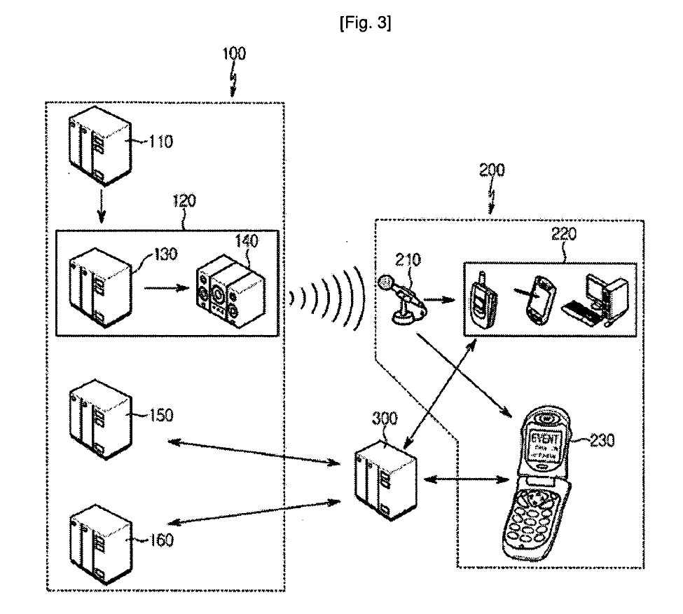

FIG. 3 schematically illustrates a system for providing information to a user using an audio watermarking according to the present invention.

The system of the present invention consists of a service providing unit 100 for providing an information data using an audio watermarking, and a user unit 200 for receiving the information data.

The service providing unit 100 includes a signal generating means 110 for generating an audio signal having the information data, and a signal transmitting means 120 for transmitting the audio signal to a user terminal, and may further include an information extracting means 150 for extracting the information data from the audio signal, and a contents providing means 160 for providing contents related to the information data.

The user unit 200 includes a receiving means 210 for receiving the audio signal having the information data, and user terminals 220 and 230 for providing the user with the information data inserted in the received audio signal. Here, the user terminals 220 and 230 may be mobile phones, PDAs or PCs, and may have the receiving means 210 for receiving the audio signal according to characteristics of the terminals.

And, if the user terminal 230 has a function therein for extracting the information data from the audio signal, the present invention extracts the information data directly from the user terminal 230 and provides the information data to the user, but if the user terminal 220 does not have a function therein for extracting the information data from the audio signal, the present invention connects the user terminal 220 to the information extracting means 150 of the service providing unit 100 for extracting the information data from the audio signal to extract the information data from the audio signal, and provides the information data to the user.

Further, the system according to the present invention may consist of a gateway server 300 in conformity to a communication method of each of the user terminals 220 and 230 so that the user terminals 220 and 230 are connected to the information extracting means 150 and the contents providing means 160 of the service providing unit 100.

Hereinafter, each of components of the system for providing information using an audio watermarking according to the present invention is described in detail through exemplary embodiments.

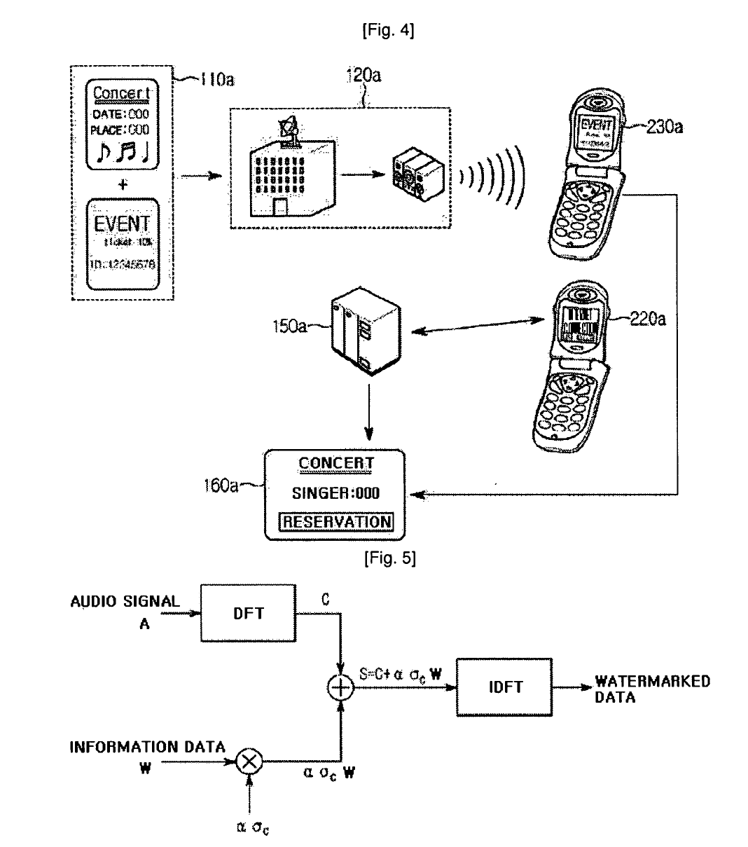

FIG. 4 illustrates an embodiment in which information is provided to a user using an audio watermarking.

If a discount coupon is provided to obtain favorable responses from more people on advertising a concert, a signal generating means 110a inserts an event coupon information into a sound source for advertisement of the concert to generate an advertising audio signal, as shown in FIG. 4. The generated advertising audio signal is transmitted through a signal transmitting means 120a, and in this embodiment, the advertising audio signal is transmitted using sky wave broadcast to provide advertisement to people located remote and more people. User terminals 220a and 230a receive the transmitted advertising audio signal, and the user terminal 230a capable of extracting an information data of the event discount coupon from the advertising audio signal directly provides the information data of the event discount coupon to the user. However, if the user terminal 220a does not have an information data extracting function or the information data is to be extracted more rapidly and effectively, the user terminal 220a is connected to an information extracting server 150a capable of extracting the information data. Then, the information extracting server 150a extracts the information data of the event discount coupon and transmits the extracted information data to the user terminal 220a to provide the information data to the user.

Further, a URL information related to the concert may be included in the information data, and the user terminals 220a and 230a may be connected to a corresponding server of the URL to receive a detailed information related to the concert.

According to the above-mentioned system of the present invention, the user listens to the concert advertisement, i.e. a primary information, and is immediately provided with information about the discount coupon, i.e. a secondary information, and moreover the user is directly connected to a corresponding server to receive the related contents information.

More preferable configuration and operational relation of each of the components are described in detail.

The present invention calculates a frequency domain of a sound source, and inserts an information data into the frequency domain using a watermarking method, and calculation of the frequency domain uses DFT (Discrete Fourier Transform).

FIG. 5 schematically illustrates a configuration in which information data is inserted into a sound source using watermarking according to the present invention.

As shown in FIG. 5, a general sound source (an audio signal) A is converted into a frequency domain through DFT to calculate a signal of frequency domain as a complex number, and a cover signal c, i.e. a signal of frequency domain is calculated using an absolute value thereto. And, to insert an information data w to be communicated using a watermarking method, the information data is multiplied by a scaling factor ασ_{c} generate watermarking ασ_{c}w.

And, a standard deviation ασ_{c} of the cover signal is used to insert the information data in proportion to an average power of the cover signal thereby to generate a signal s of frequency domain having the information data as shown in FIG. 5, that is, s=c+ασ_{c}w.

The signal s is a signal of frequency domain, and thus when the signal is converted into a signal of time domain through IDFT to generate a watermarked audio signal having the information data.

As such, the present invention converts a sound source into a frequency domain through DFT and inserts an information data into the frequency domain, and thus can generate an audio signal having the information data of high robustness against an attack to remove or transform the information data, while a user does not recognize the inserted information data.

Further, the present invention inserts an information data in an audible frequency band, in particular, a low frequency domain of 500 Hz to 5000 Hz among frequency domain of the sound source, thereby resulting in reduced damage caused by compression or filtering and strong robustness against an attack.

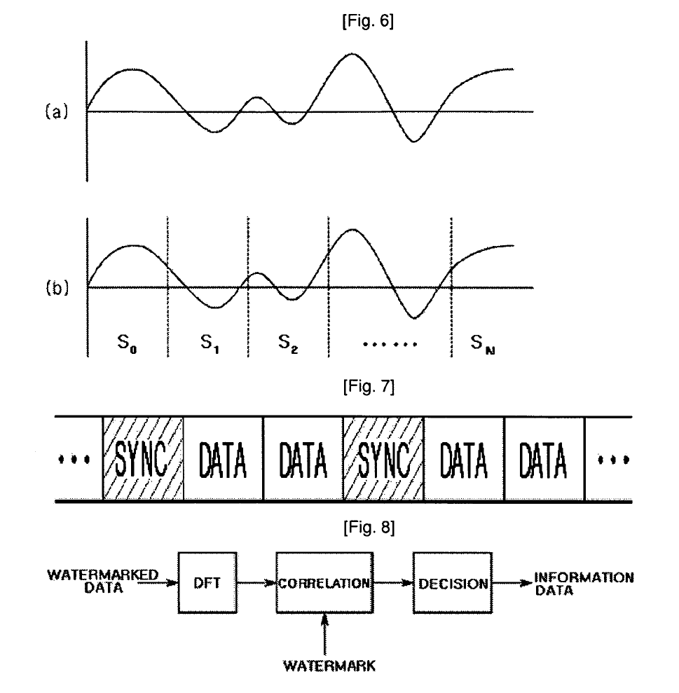

More further, FIG. 6(a) shows an example of a general sound source, and as shown in FIG. 6(b), the general sound source (an original sound signal) of FIG. 6(a) is divided into the N number of segment blocks (B₀, B₁, B₂, . . . , B_{N}), each segment block is

divided into a plurality of samples, and DFT is performed on each of the segment blocks. Taken detection time and capacity into consideration, it is preferred to divide a segment block into 8192 samples.

And, when the information data is inserted, a sync watermark representing a start portion of the information data is inserted, and after the sync watermark is inserted once, the information data is inserted at least once, and this step is repeated over the entire domain of the audio signal.

FIG. 7 illustrates an embodiment in which the sync watermark is inserted, and after the sync watermark is inserted once, the information data is inserted twice, taken detection time and capacity into consideration.

Further, in order to increase the capacity for insertion of the information data, 256 data watermarks are defined for the information data and 1 byte of information is inserted into each block of the data watermark.

An audio signal having the information data is generated, and then the audio signal is processed by the signal transmitting means 120 and transmitted to the user, and may be transmitted to a user located at a long distance or a plurality of users by sky wave broadcast, and may be transmitted in various audio files, for example MP3, WAV or MPEG, or moving image files. For this purpose, the signal transmitting means 120 may include a signal processing means 130 for transmitting the audio signal having the information data as a suitable signal and a signal output means 140 located near the user.

As such, the present invention inserts the information data into the audio signal in the user's unrecognizable range, and performs watermarking in an optimum condition to reduce damage of the information data. Further, the present invention may transmit the audio signal having the information data online or offline.

The user unit 200 receives the audio signal having the information data through the receiving means 210, and the user terminal 230 extracts the information data from the audio signal having the information data and provides the extracted information data to the user. Further, in the case that the user terminal 220 does not have a function for extracting the information data from the audio signal, the present invention may extract the information data through the information extracting means 150 of the service providing unit 100.

And, it is described about a step for extracting the information data by the user terminal 230 or the information extracting means 150 of the service providing unit 100.

The information data input in a frequency domain, is extracted in the frequency domain and provided to the user, and preferably the information data is input in a frequency domain by DFT and the information data is extracted from the audio signal having the information data through DFT in the frequency domain.

FIG. 8 schematically illustrates a configuration in which the information data is extracted from the audio signal having the information data in accordance with the present invention.

After the audio signal is input, the audio signal is converted into a frequency domain through DFT to generate a signal of frequency domain as a complex number value, and thus a signal of frequency domain is calculated using an absolute value thereto. The information data is executed a correlation detection from the calculated signal of frequency domain, and in the ease that correlation detection is made using the same signal as the inserted information data, a peak value exists only by the same signal as an information data inserted at a location where the information data is inserted, among the calculated signals of frequency domain. The information data inserted by correlation detection can be restored.

Further, in the present invention, a sync watermark representing a start portion of the information data is inserted when generating the audio signal having the information data, and the sync watermark is searched to find the start portion of the information data when extracting the information data. More further, correlation detection is made while skipping over at a predetermined interval using a characteristic of DFT domain when searching the sync watermark, thereby reducing a detection time. Preferably, correlation detection is made while skipping over 100 samples.

And, to increase the capacity for insertion of the information data, 256 watermarks may be defined for the information data watermark and inserted into the audio signal, and when detecting the information data watermark, 256 times of correlation tests are made using the 256 defined watermarks to extract the information data watermark.

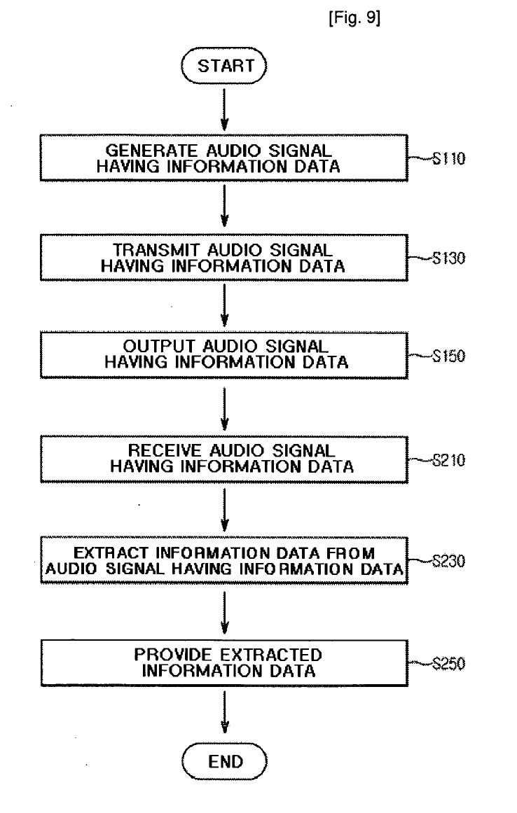

As such, the present invention suggests a method for providing information to a user using the system for providing information through an audio watermarking, and FIG. 9 is a schematic flowchart of a method for providing information using an audio watermarking in accordance with the present invention.

First of all, the method starts with a step (S110) for inserting an information data into a general sound source using watermarking to generate an audio signal having the information data. This exemplary embodiment shows the audio signal is generated by inserting the information data into the sound source through a watermarking method, but a method suitable for conditions among various watermarking methods may be applied, for example an echo insertion method, a method for inserting into a frequency domain or a bandwidth diffusion method.

The generated audio signal is transmitted to an audio output device located near a user (S130), may be processed as a sky wave signal or a compressed file and transmitted for providing a user located at a long distance or a plurality of users, and the audio signal is output through the audio output device located near the user (S150).

When the audio signal is output, the user terminals 220 and 230 receives the audio signal through the receiving means 210 (S210), and extracts the information data from the received audio signal (S230), and in the case that the user terminal 230 has a function for extracting the information data from the audio signal, the user terminal 230 extracts the information data by itself however, the information data may be extracted using the conventional terminal 220 or the extracting means 150 of the service providing unit 100 for faster and more effective extraction of the information data.

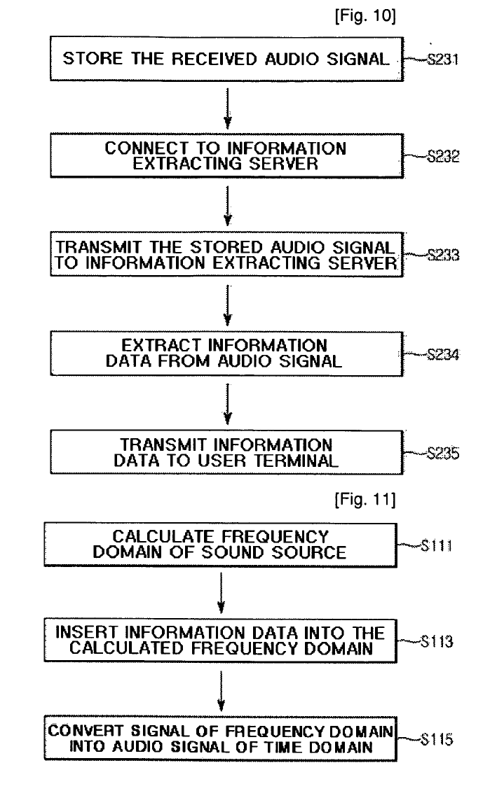

A step for extracting the information data using the extracting means 150 of the service providing unit 100 is described in detail through FIG. 10, first, the received audio signal is stored in the user terminal 220 (S231), and the user terminal 220 is connected to the information extracting server 150 for extracting the information data through an Internet network (S232). When the user terminal 220 is connected to the information extracting server 150, the audio signal stored in the user terminal 220 is transmitted to the information extracting server 150 (S233), and the information extracting server 150 extracts the information data from the audio signal (S234). In the case that the information data is successfully extracted, the information extracting server 150 transmits the information data to the user terminal 220 (S235).

As such, the information data is extracted using the information extracting server 150 of the service providing unit 100, and thus it is possible to provide the information data to the conventional user terminal 220 not having an information extracting function and to extract the information data faster and more effectively through the enhanced user terminal 230 having an information extracting function.

Further, a step (S110) for generating the audio signal having the information data is described in detail with reference to FIG. 11, and a frequency domain of the general sound source is calculated (S111), the information data is inserted in the calculated frequency domain (S113), and the signal of frequency domain having the information data is converted into an audio signal of time domain (S115) to generate an audio signal having the information data.

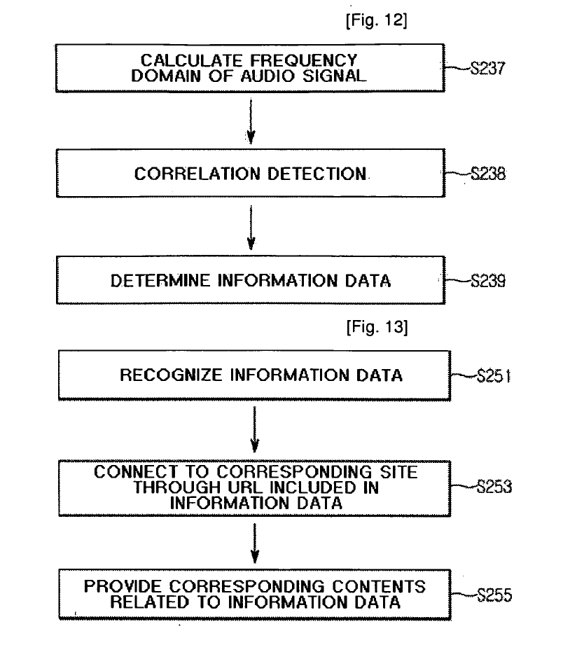

As shown in FIG. 12, in the step (S230) for extracting the information data through the method of FIG. 10 from the audio signal generated by inserting the information data, a frequency domain of the audio signal is calculated (S237), correlation detection is made using the same signal as the inserted information data over the entire domain of the calculated frequency (S238), and the information data is determined based on existence of a peak value (S239) to extract the inserted information data.

Preferably, an audio signal having the information data inserted through watermarking of higher transparency and robustness is provided using a method of the above-mentioned system according to the present invention.

More further, as shown in FIG. 13, in a step (S250) for providing the user with the information data extracted by the above-mentioned step, the user terminal recognizes the extracted information data (S251), and in the case that the information data includes a URL, the user terminal connects to a site corresponding to the URL (S253) to provide the user with the information data and its related corresponding contents (S255).

As such, the present invention inserts a secondary information data into a primary sound source using an audio watermarking, thereby providing a user with an information data regardless of time, space, and online or offline, and further providing the user with corresponding contents related with the information data.

Described above are the example embodiments of a system, user terminal and method for providing information using an audio watermarking method according to the present invention. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to the above-mentioned the present invention, when obtaining a primary information through a watermarked audio signal, a user is provided with a secondary information by extracting an information data from the audio signal watermarked by the present invention, if necessary, and is provided with necessary information regardless of time, space and online or offline.

And, the present invention uses a separate information extracting means from a user terminal, and thus the information data included in the audio signal can be provided by a conventional terminal without an information extracting function, and in the case that an enhanced terminal having an information data extracting function is used, the information data can be extracted through the information extracting means faster and more effectively.

Moreover, when inserting the information data using a watermarking method, the present invention inserts the information data in an audible frequency band, in particular, a low frequency domain of 500 Hz to 5000 Hz among frequency domain of the audio signal, thereby reducing damage caused by compression or filtering to allow high robustness against an external attack.

Further, when generating a watermarked audio signal, the present invention inserts a sync watermark representing a start portion of the information data once and then inserts at least one information data, and when extracting the information data, searches the sync watermark while skipping over at a predetermined interval using a characteristic of DFT domain and makes a correlation detection of the information data, thereby reducing a detection time.

1. A system for providing information using an audio watermarking, which inserts a specific information into a general sound source by a watermarking technique to provide the information to a user, the system comprising:
a signal generating means for inserting an information data into a sound source to generate an audio signal;
a signal transmitting means for transmitting the audio signal generated by the signal generating means to a user terminal; and
an information extracting means for extracting the inserted information data from the audio signal,
wherein the information extracting means is configured separately from the user terminal, and receives the audio signal from the user terminal, extracts the information data from the audio signal, transmits the extracted information data to the user terminal to provide the information data to the user.

2. The system for providing information using an audio watermarking according to claim 1,
wherein the user terminal for receiving the audio signal having the information data and providing the information data to the user, includes:
a receiving means for receiving the audio signal;
a storage means for storing the audio signal; and
an information managing means for transmitting the audio signal to the information extracting means configured separately from the user terminal, receiving the extracted information data from the information extracting means and providing the information data to the user, and
wherein the user terminal extracts the information data from the audio signal through the information extracting means configured separately from the user terminal and provides the information data to the user.

3. The system for providing information using an audio watermarking according to claim 1,
wherein the signal generating means inserts information to be provided to the user into a frequency domain of the sound source through DFT (Discrete Fourier Transform) and converts a signal of frequency domain having the information into a signal of time domain through DFT (Inverse Discrete Fourier Transform) to generate the audio signal having the information.

4. The system for providing information using an audio watermarking according to claim 3,
wherein the sound source is divided into segment blocks, each segment block is divided into a plurality of samples, and a frequency domain of each segment block is calculated through DFT.

5. The system for providing information using an audio watermarking according to claim 3,
wherein the information data is inserted in a frequency domain of 500 Hz to 5000 Hz among frequency domain of the sound source.

6. The system for providing information using an audio watermarking according to claim 3,
wherein, after a sync watermark representing a start portion of the information data is inserted once, the information data is inserted at least once, and this step is repeated over the entire domain of the sound source.

7. The system for providing information using an audio watermarking according to claim 1 or 2,
wherein the information extracting means calculates a frequency domain of the audio signal through DFT, extracts the inserted information through correlation detection in the calculated frequency domain, and transmits the information to the user terminal.

8. The system for providing information using an audio watermarking according to claim 7,
wherein the audio signal is divided into segment blocks, and the correlation detection is made skipping over at a predetermined interval in each segment block.

9. An method for providing information using an audio watermarking, which inserts a specific information into a general sound source to provide the information to a user, the method comprising:
inserting an information data to he provided to the user into a sound source to generate an audio signal having the information data;
transmitting the audio signal to an audio output device adjacent to the user;
receiving the audio signal through a user terminal;
extracting the information data from the audio signal; and
providing the information data to the user.

10. The method for providing information using an audio watermarking according to claim 9,
wherein the step of extracting the information data includes:
storing the audio signal into the user terminal;
the user terminal connecting to an information extracting server to transmit the audio signal thereto;
the information extracting server extracting the information data from the audio signal; and
the information extracting server transmitting the extracted information data to the user terminal.

11. The method for providing information using an audio watermarking according to claim 9,
wherein, in the step of transmitting the audio signal, the audio signal is transmitted as a sky wave broadcasting signal, and received by the audio output device adjacent to the user.

12. The method for providing information using an audio watermarking according to claim 9, further comprising:
the user terminal operating a link program based on the information data.

13. The method for providing information using an audio watermarking according to claim 9,
in the case that the information data contains a URL (Uniform Resource Locator) information,
further comprising: connecting the user terminal to a corresponding site based on the URL information.

14. The method for providing information using an audio watermarking according to claim 13, further comprising:
when the user terminal is connected to the corresponding site, a server of the corresponding site providing a corresponding content to the user based on the information data.
